(19) United States
(12) Patent Application Publication
(10) Pub. No.: US 2015/0166006 A1
(43) Pub. Date: Jun. 18, 2015

(54) SEAT BELT EXTENDER

(71) Applicant: Tammy Cannady, Seligman, MO (US)

(72) Inventor: Tammy Cannady, Seligman, MO (US)

(21) Appl. No.: 14/512,338

(22) Filed: Oct. 10, 2014

Related U.S. Application Data
(60) Provisional application No. 61/915,709, filed on Dec. 13, 2013.

(51) Int. Cl. B60R 22/30

(52) U.S. Cl. CPC B60R 22/30

(57) ABSTRACT

A seat belt extender for allowing a user to increase length of a conventional seat belt assembly. The seat belt extender comprises a strap member with a clasp member at its distal end and a buckle member at its proximal end. The seat belt extender is used in conjunction with conventional seat belt components a conventional seat belt clasp is connected to the buckle member so that it engages and interlocks as when the conventional seat belt clasp interlocks the with conventional seat belt buckle and the clasp member is connected to the conventional seat belt buckle so that it engages and interlocks as when the conventional seat belt clasp interlocks with the conventional seat belt buckle.

### CROSS REFERENCE TO RELATED APPLICATIONS

This application claims the benefit of and incorporates by reference co-pending U.S. provisional patent application Ser. No. 61/915,709 filed Dec. 13, 2013.

### BACKGROUND OF THE INVENTION

1. Field of the Invention

This invention relates generally to safety devices and, more particularly, to a vehicle seat belt extending device which allows a user to increase the length of seat belt straps.

2. Description of the Prior Art

The use of seat belts in motor vehicles is well known. Standard seat belts are defined by a strap which extends from a retractor directly to a buckle and a strap which extends from the retractor to the buckle by way of a shoulder sash. In this configuration, the length of the seat belt is structurally limited by the amount of strap which rests outside the retractor, can be stored in the retractor, and can otherwise be manipulated by the retractor. This structural limitation generally considered to be important for safety as a longer strap may be more difficult for the retractor to control and a strap that was not fixed in length may not provided sufficient protection. This structural limitation, however, means that for users who sit very close to the steering wheel while driving or for overweight users, the seat belt strap may not be long enough to extend around them and completely across to the buckle. Thus, a problem which still exists is that the fixed length nature of seat belt straps limits their use by certain users. Consequently, there remains a need for a seat beat extender which would allow additional length to be added to a seat belt. It would be helpful if such a seat belt extender utilized the same strap material and clasp/buckle design so as to provide standardized security and widespread compatibility. It would be additionally desirable for such a seat belt extender to allow for adjustments in length by moving the buckle.

The Applicant's invention described herein provides for a seat belt extender for allowing additional length to be added to a vehicle seat belt. The primary components of Applicants' seat belt extender are a extension strap, an extension clasp and an extension buckle. When in operation, the seat belt extender allows a user to securely extend the length of her seat belt with a removable device adapted to be compatible in a plurality of motor vehicles. As a result, many of the limitations found in the prior art are avoided.

### SUMMARY OF THE INVENTION

A seat belt extender for allowing a user to increase length of a conventional seat belt assembly. The seat belt extender comprises a strap member with a clasp member at its distal end and a buckle member at its proximal end. The entire length of the seat belt extender extends eight to ten inches, and, in some embodiments, is adjustable in length due to an ability to unlock and move the buckle member from a first location along the strap member to a second location on the strap member.

In operation, the seat belt extender is used in conjunction with conventional seat belt components a conventional seat belt clasp is connected to the buckle member so that it engages and interlocks as when the conventional seat belt clasp interlocks the with conventional seat belt buckle and the clasp member is connected to the conventional seat belt buckle so that it engages and interlocks as when the conventional seat belt clasp interlocks with the conventional seat belt buckle. The seat belt extender is removed by disengaging and disconnecting the clasp member from the conventional seat belt buckle and the conventional seat belt clasp from the buckle member.

It is an object of this invention to provide a seat beat extender which would allow additional length to be added to a seat belt.

It is another object of this invention to provide a seat belt extender which utilizes the same strap material and clasp/buckle design so as to provide standardized security and widespread compatibility.

It is yet another object of this invention to provide a seat belt extender which allowed for adjustments in length by moving the buckle.

These and other objects will be apparent to one of skill in the art.

### BRIEF DESCRIPTION OF THE DRAWINGS

FIG. 1 is a top plan view of a seat belt extender built in accordance with the present invention.

### DETAILED DESCRIPTION OF THE INVENTION

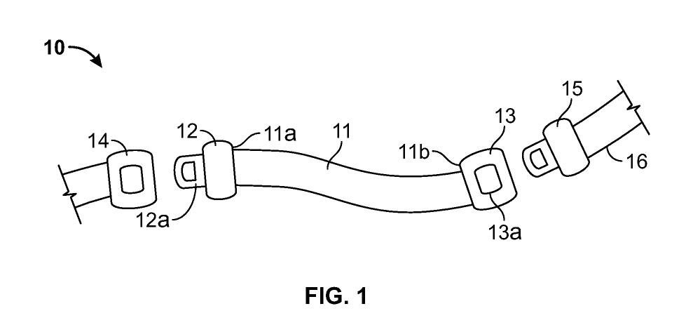

Referring now to the drawings and in particular FIG. 1, a seat belt extender 10 is shown having a strap member 11 with a distal end 11a and a proximal end 11b, with a clasp member 12 disposed at the distal end 11a and a buckle member 13 disposed at the proximal end 11b. The entire length of the seat belt extender 10 extends eight (8) inches in the preferred embodiment. In an alternate embodiment, the entire length of the seat belt extender 10 extends ten (10) inches. In one embodiment, the seat belt extender 10 is adjustable in length due to an ability to unlock and move the buckle member 13 from a first location along the strap member 11 to a second location on the strap member, where it is then re-locked in place.

In operation, the seat belt extender 10 is used in conjunction with conventional seat belt components, defined as a conventional seat belt buckle 14 and a conventional seat belt clasp 15. In a conventional arrangement the conventional seat belt clasp 15 directly engages the conventional seat belt buckle 14 to interlock and secure the seat belt assembly. As such, the length of the seat belt is structurally constrained to the available length of the conventional strap 16 attached to the conventional seat belt clasp 15, wherein said conventional strap 16 is customarily fed from a retractor (not shown). When a seat belt extender 10 is employed, the conventional seat belt clasp 15 is connected to the buckle member 13 so that it engages and forms a secure interlock in substantially the same manner as when the conventional seat belt clasp 15 interlocks the conventional seat belt buckle 14. The buckle member 13 is adapted to receive the conventional seat belt clasp 15 and allow it to be disengaged and disconnected through pressing disengaging button 13a. Then, the clasp member 12 is connected to the conventional seat belt buckle 14 so that it engages and forms a secure interlock in substantially the same manner as when the conventional seat belt clasp 15 interlocks the conventional seat belt buckle 14. The clasp member 12 includes an engaging member 12a which is adapted to allow it to engage to and disengage from the conventional seat belt buckle 14 in this manner.

To remove the seat belt extender 10, the clasp member 12 is disengaged and disconnected from the conventional seat belt buckle 14, which also opens the seat belt assembly, and the conventional seat belt clasp 15 is disengaged and disconnected from the buckle member 13.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A seat belt extender for attaching between a conventional seat belt clasp and conventional seat belt buckle, comprising:
an elongated strap member having a proximal end and a distal end;
a first attachment member disposed at the proximal end of the strap member, wherein said first attachment member enables a conventional seat belt clasp to be removably connected to said proximal end; and
a second attachment member disposed at the distal end of the strap member, wherein said second attachment member enables a conventional seat belt buckle to be removably connected to said distal end.

2. The seat belt extender of claim 1, wherein said first attachment member additionally includes a disengaging actuator that allows the disconnecting of a conventional seat belt clasp that has been connected to the proximal end.

3. The seat belt extender of claim 2, wherein said first attachment member defines a buckle member.

4. The seat belt extender of claim 3, wherein said disengaging actuator defines a disengaging button.

5. The seat belt extender of claim 1, wherein said first attachment member defines a buckle member.

6. The seat belt extender of claim 5, wherein said buckle member includes a disengaging button for disconnecting of a conventional seat belt clasp that has been connected to the proximal end.

7. The seat belt extender of claim 1, wherein said second attachment member defines a clasp member configured to connect to a conventional seat belt buckle so that it engages and forms a secure interlock in substantially the same manner as when the conventional seat belt clasp interlocks the conventional seat belt buckle.

8. The seat belt extender of claim 7, wherein an engaging member configures said clasp member to connect to a conventional seat belt buckle.

9. The seat belt extender of claim 1, wherein said strap member extends at least eight inches.
